(19) United States
(12) Patent Application Publication
(10) Pub. No.: US 2005/0148297 A1
(43) Pub. Date: Jul. 7, 2005

(54) Method for providing real&minus; time broadcast service in the mobile communcation network

(76) Inventors: Yifeng Lu, Guangdong (CN); Chengjun Li, Guangdong (CN); Hai Zeng, Guangdong (CN); De Chen, Guandong (CN)

Correspondence Address: HARNESS, DICKEY & PIERCE, P.L.C., P.O. BOX 828, BLOOMFIELD HILLS, MI, 48303, US

(21) Appl. No.: 10/502,502

(22) PCT Filed: Jan. 21, 2003
(86) PCT No.: PCT/CN03/00053

(30) Foreign Application Priority Data
Jan. 23, 2002 (CN) 02100607.5
Jan. 23, 2002 (CN) 02100608.3

(51) Int. Cl. H04H 7/00

(52) U.S. Cl. 455/3.06; 455/436; 455/458

(57) ABSTRACT

The present invention relates to a method for providing real-time broadcast service in a mobile communication system, which is especially adapted to provide real-time broadcast service in the 3^{rd} generation Code Division Multiple Access (CDMA) mobile communication system. The method comprises: adding a broadcast service hierarchy for specially providing real-time broadcast service in an radio access network having an original service hierarchy for providing voice communication; real-time broadcasting the real-time broadcast service which is accessed to the mobile communication network to mobile terminals via air interface of the mobile communication network through setting special broadcast resources, namely special carriers or special scrambling codes; the mobile terminal working in either of an original service hierarchy mode and a broadcasting service hierarchy mode which can be switched with each other. When the special carriers are adopted, only independent down-link carrier frequency is set in the broadcast service hierarchy, the mobile terminal solely controls the cell switching when moving among cells and monitors the paging procedure. When the special scrambling codes are adopted, the down-link scrambling codes of original service hierarchy and the newly added down-link special scrambling codes are utilized in each cell of both the original service hierarchy and the broadcast service hierarchy.

### FIELD OF THE TECHNOLOGY

The present invention relates to mobile communication technology field, especially to a method for implementing real-time broadcast in the 3^{rd} generation Code Division Multiple Access (CDMA) mobile communication system, namely a method for providing real-time broadcast service in a mobile communication network by setting special broadcasting resources.

### BACKGROUND OF THE INVENTION

In the prior 2^{nd} generation mobile communication system, the provided services are simplex due to bandwidth limitation. For instance, the voice communication is the major service. In the 2.5^{th} generation mobile communication system although data service has been developed, the application is confined in information inquiry service because of the data rate limitation. In the prospective 3^{rd} generation mobile communication system multimedia service will be provided, possibly leading to multimedia broadcast service and multicast service in the 3^{rd} generation mobile communication system.

At present there are two ways for providing broadcast service at the mobile terminal:

(1) Integrating radio receiver or television receiver in the mobile terminal, receiving the broadcast program provided by the existing wireless broadcasting network or television network to listen or watch. The advantage is that the existing network resources are utilized and no modification for the mobile network is needed. However the disadvantage is quite apparent too. As radio circuit or television receiver circuit needs to be integrated in the mobile terminal, the cost of mobile terminal will be greatly increased. Especially, when a television receiver is being integrated, there are the problems of great integrating difficulty and no guarantee for receiving effect.

(2) Utilizing mobile network to provide video on demand or audio on demand. For instance, since the broadcast channel capacity is not sufficient, the existing channel can only transmit data with low speed and low requirement for real-time performance in the technology criterion of the prior 3^{rd} generation mobile communication system. As to the television programs or broadcasting programs with high speed and high requirement for real-time performance, the service cannot be provided but through video on demand by users. The disadvantage is that as to some broadcasting programs with high real-time performance, such as live television news and sports programs, the network resources cannot be shared because video on demand for each user must occupy one channel, leading to the waste of resources. Furthermore, due to the resource limitation, it is impossible to meet the requirement that large amounts of users are watching programs at the same time.

### SUMMARY OF THE INVENTION

A main object of the present invention is to propose a method for providing real-time broadcast service in the existing mobile communication network, in which real-time broadcast service is provided by setting special broadcast resources with large coverage, namely special scrambling codes or special carriers.

To achieve the above-mentioned object, the specific technical scheme of this invention is as follows: a method for providing real-time broadcasting service in a mobile communication network, comprising:

A. linking real-time broadcast service to the mobile communication network;

B. adding a broadcast service hierarchy for specially providing real-time broadcast service in an radio access network having an original service hierarchy for providing voice communication; real-time broadcasting the real-time broadcast service to mobile terminals via air interface of the mobile communication network through setting special broadcast resources; the mobile terminal working in either of an original service hierarchy mode and a broadcasting service hierarchy mode which can be switched with each other.

In step A described above, the content information of real-time broadcast service is transmitted to an information transmitting server firstly; then accessed to the mobile communication network by the information transmitting server.

In the present invention, two different technical schemes for implementing step B are devised by setting two kinds of special broadcast resources, namely special carrier resources and special scrambling code resources.

Under the condition that special carrier resources are adopted as special broadcast resources, step B further comprises:

setting only independent down link carrier frequency in the added broadcast service hierarchy for specially providing real-time broadcast service; dividing the broadcast service hierarchy into cells where adjacent cells employ different scrambling codes and defining multiple cells into one location area; under the broadcast service hierarchy mode, the mobile terminal staying in the cell of broadcast service hierarchy, making handoff when the terminal moves among cells, and monitoring the paging channel.

Under the condition that special scrambling code resources are adopted as special broadcast resources, step B further comprises:

setting independent down link special scrambling codes in the added broadcast service hierarchy for specially providing real-time broadcast service; wherein the locations of cells of the broadcast service hierarchy and those of the original service hierarchy are superposed so as to form the structure of the cell of the original service hierarchy plus the cell of the broadcast service hierarchy, and each cell utilizes the same special down link scrambling code and the same special broadcast channel code for transmitting real-time broadcast information; said down link special scrambling codes for real-time broadcast service are added only in macro cells but micro cells or pico cells; the working mode of mobile terminal keeps unchanged for the original service, pilot channel of the original cell is shared and real-time broadcast service is supported under both idling mode and connecting mode.

In the present invention, real-time broadcast service with high data rate can be supported by setting special carrier in the prior mobile communication system. When setting special carrier the cell coverage and location division of broadcast service hierarchy and the original service hierarchy can be either superposed or not. When using the special carrier, paging information is sent in the broadcast service hierarchy; when using the special carrier and there is only one set of receiver system in the terminal, the terminal sends location update information through the original service hierarchy and receives the confirming information through the broadcast service hierarchy. When using the special carriers, the service providers providing real-time broadcast service can activate or shutdown the transmitting signals of broadcast service in response of requirements.

With the method according to this present invention, real-time service with high data rate, such as real-time broadcast service, can be supported by setting special scrambling codes in the prior mobile communication system. When using the special scrambling codes, each cell of the broadcast service hierarchy utilizes the same scrambling code and channel code. When using the special scrambling codes, range and location division of the cell of the original service hierarchy plus broadcast service hierarchy is the same as that of the macro cell of the original service hierarchy. When using the special scrambling codes, the mobile terminal can implement interfere canceling with known information about broadcast service scrambling code and channel code, channel estimation information of the current cell and adjacent cells as well as demodulated broadcast service information so as to improve the receiving ability for other service channels. When using the special scrambling codes, the service providers providing real-time broadcast service can activate or shutdown the transmitting signals of broadcast service in response of requirements.

Accordingly, compared with the prior art, the method for providing real-time broadcast service in a mobile communication network according to the present invention has the following advantages:

1. The mobile terminal can receive television programs and radio programs with the existing function modules. There is no need to set additional receiving circuit, which is helpful for increasing the integration degree of the mobile terminal and decreasing device cost.

2. The receiving effect of the mobile terminal when receiving broadcast programs is guaranteed by making use of the existing vast covering mobile network to support real-time broadcast service.

3. Compared with the mode of program on demand and that of the user accessing broadcast program independently, since the same one network source supporting real-time broadcast service can provide real-time broadcast service to more than one mobile user simultaneously, the capacity factor and system capacity of wireless resources are increased.

### BRIEF DESCRIPTION OF THE DRAWINGS

FIG. 1 is a schematic diagram illustrating network structure of the mobile communication system for providing real-time broadcast service.

FIG. 2 is a schematic diagram illustrating cell structure of setting single down link carrier when the special carrier resources are adopted.

FIG. 3 is a schematic diagram illustrating frequency setting of the down link special carrier when the special carrier resources are adopted.

FIG. 4 is a block diagram illustrating system structure and operating principle of mobile terminal when the special carrier resources are adopted.

FIG. 5 is a schematic diagram illustrating cell structure of setting single down link special scrambling codes when the special scrambling code resources are adopted.

FIG. 6 is a schematic diagram illustrating flow chart of transmitting procedure in the base station when the down link special scrambling codes are set.

FIG. 7 is a block diagram illustrating system structure and operating principle of mobile terminal when the special scrambling code resources are adopted.

### DETAILED DESCRIPTION OF THE INVENTION

Now, the present invention will be described in detail hereinafter with reference to the accompanying drawings.

In the present invention, real-time broadcast service is provided by setting special broadcast resources with large coverage property in the existing 3^{rd} generation mobile communication network, namely by setting special scrambling codes or special carriers.

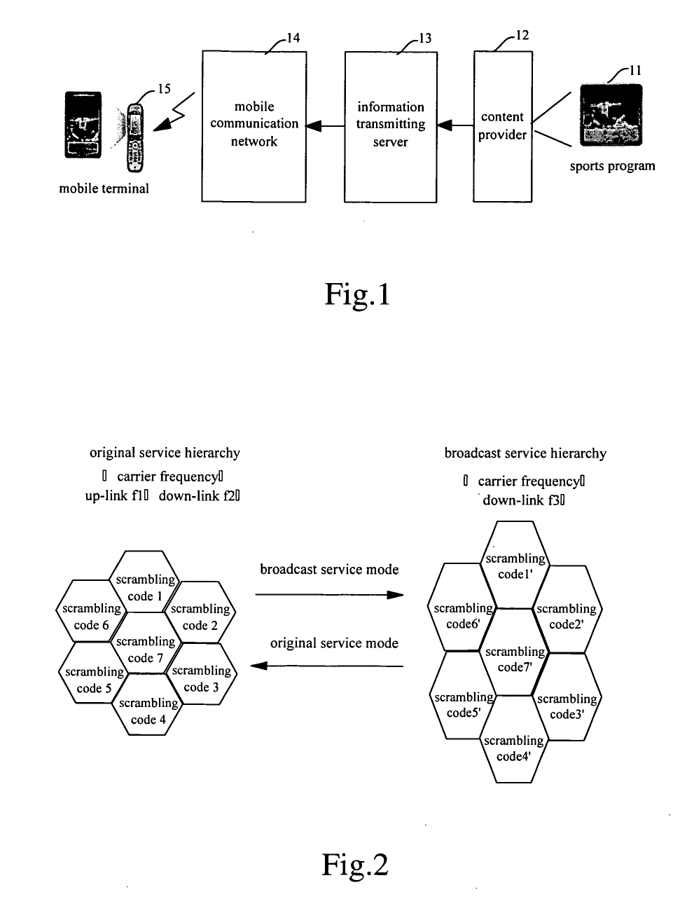

FIG. 1 shows the network structure of the mobile communication system when the special broadcast resources are adopted to provide real-time broadcast service. A live sports program 11 is provided to a live broadcast service content provider 12, then the content provider 12 transmits this live sports program to an information transmitting server 13. The information transmitting server 13 accesses the program to a mobile communication network 14, at the air interface of the mobile communication network 14 this live sports program is broadcast real-timely to a mobile terminal 15 by setting special broadcasting resources (special carriers or special scrambling codes). The mobile terminal 15 operates with the original service hierarchy mode or broadcast service hierarchy mode, which can be switched with each other. Wire connection mode can be adopted between the content provider 12, the information transmitting server 13 and the mobile communication network 14.

With reference to FIG. 2, this figure illustrates the structure and operating principle of wireless access network when the technology scheme using special carriers is adopted. This is the system structure after the broadcast service mode is newly added.

In the technology scheme using special carriers according to the present invention, the wireless access network is divided into original service hierarchy and broadcast service hierarchy, according with the added broadcast service mode and original service mode indicated by the arrowheads. The carrier frequency of original service hierarchy includes up-link carrier frequency f1 and down-link carrier frequency f2. The original service hierarchy provides services like speech communication, data transmission, wireless internet, video on command and so on. The added broadcast service hierarchy just needs to set single down-link carrier frequency f3 in order to specially provide real-time broadcast service.

Broadcast service hierarchy is also divided into multiple cells and those adjacent cells adopt different scrambling codes shown in FIG. 2 with scrambling code1′, scrambling code2′, . . . , scrambling code7′. These scrambling codes correspond to those adopted in the original service hierarchy at physical positions shown in FIG. 2 with scrambling code1, scrambling code2, . . . , scrambling code7. But the cells in broadcast service hierarchy cover more areas than those in the original service hierarchy. Like the original service hierarchy mode, several cells in the broadcast service hierarchy can be combined into the same location area. There is no direct relationship among the scrambling codes of original service hierarchy, namely scrambling code1, scrambling code2, . . . , scrambling code7, and the scrambling codes of broadcast service hierarchy, namely scrambling code1′, scrambling code2′, . . . , scrambling code7′, that is, these scrambling codes can be either the same (the scrambling codes of broadcast service hierarchy can be scrambling code1, scrambling code2, . . . , scrambling code7) or not (shown as scrambling code1′, scrambling code2′, . . . , scrambling code7′ in FIG. 2). Moreover, the cells and location division of original service hierarchy and broadcast service hierarchy can either be superposed or not, which makes the network programming more flexible.

Broadcasting channels are set in the cells of broadcast service hierarchy so as to broadcast corresponding cell information, for example, the location area code, paging channel configuration information of the broadcast service hierarchy cell, as well as frequency, scrambling code, Random Access Channel (RACH), the public channels related to RACH such as AICH and Forward Access Channel (FACH) of the adjacent service hierarchy cells. Paging channels are also set in the cells of broadcast service hierarchy, so as to page the mobile terminals working under the broadcast service mode.

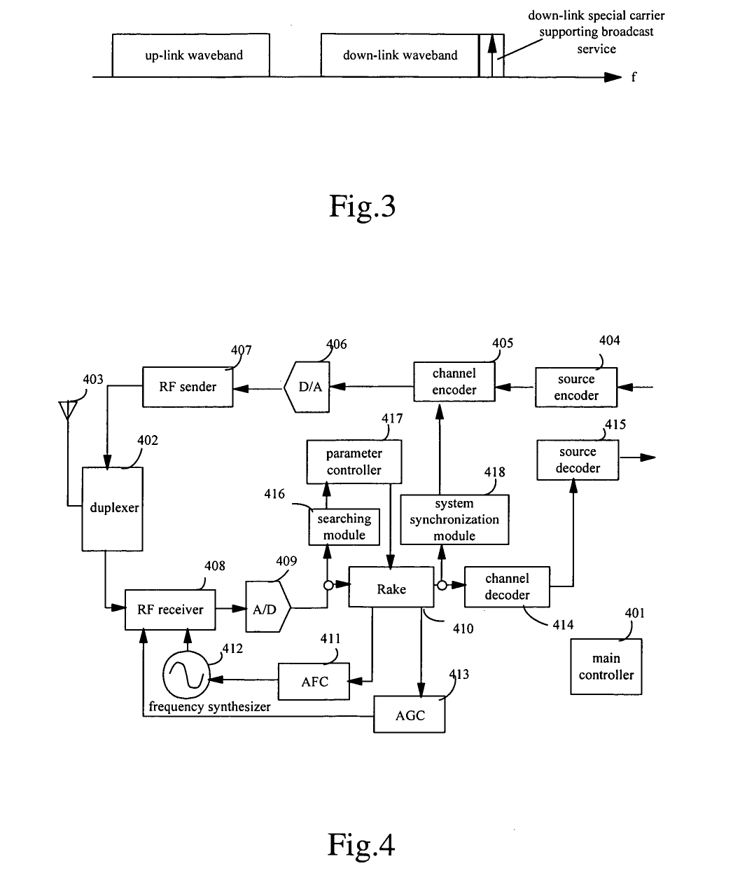

With reference to FIG. 3, the setting of down-link special carrier frequency f3 in broadcast service hierarchy is illustrated. In order to decrease the complexity of mobile terminals and avoid the down-link special carrier frequency to interfere with the original base station, illustrated by the arrowheads shown in FIG. 3, a frequency adjoining the high side of the down-link waveband should be selected as the down-link special carrier frequency to support broadcast service, along the frequency axis and behind the original up-link waveband and down-link waveband.

With reference to FIG. 4, the structure and operating principle of the mobile terminal when the technical scheme of using special carriers is adopted is illustrated. In this embodiment, only one set of receiving and synchronizing system is set up in order to reduce the cost of mobile terminal. What is shown in FIG. 4 is the hardware structure of the prior mobile terminal. This structure includes a transmitting unit which is comprised of a main controller 401, a sending unit constituted by a source encoder 404, a channel encoder 405, a Digital/Analog (D/A) converter 406 and a Radio Frequency (RF) sender 407, a receiving unit which is comprised of a Radio Frequency (RF) receiver 408, an Analog /Digital (A/D) converter 409, a frequency synthesizer 412, a searching module 416, a parameter controller 417, a RAKE combining receiver 410, an Automatic Frequency Control (AFC) module 411, an Automatic Gain Correction (AGC) module 413, a channel decoder 414, a source decoder 415 and a system synchronization module 418, as well as an antenna 403 and a duplexer 402 shared by the transmitting unit and the receiving unit.

When the mobile terminal is working under broadcast service mode, if the location registration is required for the mobile terminal, the mobile terminal selects a cell according to the frequency and scrambling code information of the adjacent cells in the original service hierarchy received in the broadcast service hierarchy, and sends the location update information, which is based on the location information of broadcast service hierarchy, to the core network. Then the mobile terminal returns to the broadcast service mode. After receiving the location update information of a certain mobile terminal, the core network sends a confirming message to the cell in broadcast service hierarchy. The specific implementation of sending location update confirming message can be carried out via the down-link channel of added carrier f3 or broadcast service channel by means of time slicing.

Accordingly, the mobile terminal can work under two modes, namely the original mobile paging service mode and the added mobile broadcast service mode. Under the original mobile paging service mode, the mobile terminal works at the original service hierarchy, stays in the cell of the original service hierarchy and operates according to the original working process. After switching to the broadcast service mode, the mobile terminal will stay in the cell of broadcast service hierarchy. When the mobile terminal is moving between different cells, handoff occurs. Since there is no upward link, the handoff procedure will be controlled only by the terminal and this handoff procedure is the same as that of the original service.

When the mobile terminal is moving among different location areas of broadcast service hierarchy, location update will be initiated and the up-link signal of location update will be sent through the original service hierarchy. In the present invention, the concept of location update is extended in term of the prior mobile network: the location update being triggered by the switching between the original service hierarchy and the broadcast service hierarchy, namely adopting the same mode as the original service hierarchy to trigger location update when location area change occurs under broadcast service mode. Through the location update, core network can exactly judge whether a certain mobile terminal is under broadcast service mode or original service mode, so as to page a terminal with pertinence.

The specific location update process under broadcast service mode is somewhat different from that under original service mode. The mobile terminal acquires the adjacent cell information in original service hierarchy through broadcast message of broadcast channel in broadcast service hierarchy, and sends out location update message through the Random Access Channel (RACH) in original service hierarchy.

For the mobile terminal with only one set of receiving system, the broadcast service has to be broken off for a short time when the location update is implemented. After the mobile terminal moves to a new cell in broadcast service hierarchy, location area change is detected by demodulating broadcast information and location update needs to be performed. Assuming that the present cell in broadcast service hierarchy is B1, the terminal obtains the information of cells adjacent to the B1 in original service hierarchy from the broadcast information of B1. The information can help the terminal to find a cell C1 as soon as possible, which is of the best communication quality and where the terminal can stay. Then the terminal initiates random access request in C1 through Random Access Channel (RACH). After receiving AICH from C1, the frequency of terminal can be tuned to broadcast frequency f3, starting searching and synchronization with B1 as early as possible. Meanwhile, the terminal sends the up-link message containing location update information using f1 and waits to receive the location update confirming message in B1.

If there are two sets of receiving systems in the terminal, the above-mentioned location update process and broadcast service can be performed simultaneously. When the location update is being performed, there is no need to break off the broadcast service.

The page monitoring function is added to the mobile terminal under broadcast service mode, the method for receiving the paging is the same as that of original service mode. The core network sends paging signal to the terminal, in detail, the core network selects the corresponding location area based on the received location information, sends down-link paging information according to broadcast service carrier frequency f3 or original service carrier frequency f2, respectively corresponding to broadcast service mode or original service mode.

The mobile terminal replies and initiates the calling through the original service hierarchy. Namely, when the user needs to reply or initiate a calling, the mode of the mobile terminal is switched to the original service hierarchy mode automatically. So, to increase the connection speed, the information of adjacent cells in original service hierarchy, such as frequency, scrambling code etc, for use by terminal, can be broadcast through broadcast channel by broadcast service hierarchy, in order to raise the searching speed of the terminal in original service hierarchy.

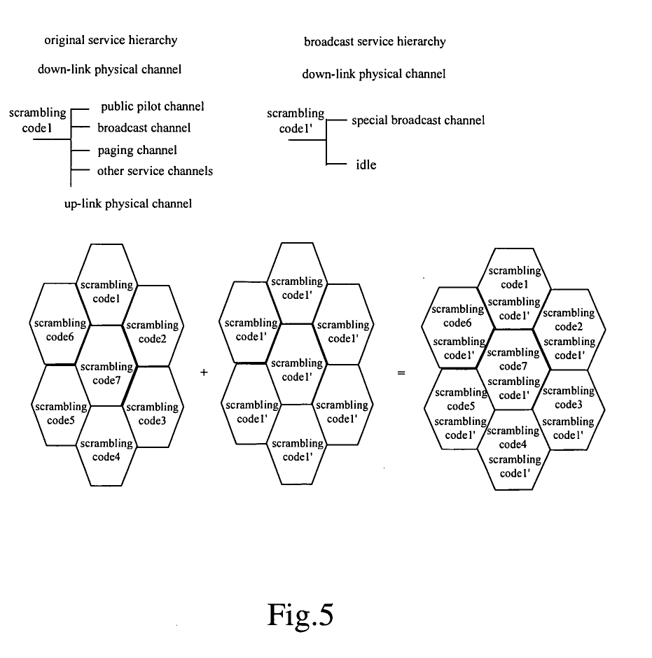

With reference to FIG. 5, this figure illustrates the structure and operating principle of the wireless access network when the technology scheme of using special scrambling codes is adopted. In this system structure, the broadcast service mode is newly added, namely, the network structure can be used to provide real-time broadcast service by adding special scrambling codes. The special scrambling codes for real-time broadcast service are only used in macro cells, and there is no need to add special scrambling codes to micro cells and pico cells.

In this technology scheme of using special scrambling codes for real-time broadcast service according to the invention, the wireless access network is divided into original mobile paging service hierarchy and newly added broadcast service hierarchy, the former providing speech communication, data transmission, wireless internet, video on command and so on, while the latter specially providing real-time broadcast service.

Since the broadcast program is totally the same in a certain area, and those cells are geographically superposed in the cell hierarchy structure of the 3^{rd} generation (3G) mobile communication system, when carrying out this scheme of special scrambling code, just a down-link scrambling code special for broadcast service needs being added to the transmitter of each cell in the original service macro cell coving hierarchy. Every cell holds the same scrambling code and channel code. This scrambling code is only for transmitting broadcasting information, while all the mobile terminals share the public pilot channels of the original cells.

FIG. 5 shows that under this technology scheme, the original service hierarchy and broadcast service hierarchy are totally superposed in the structure of macro cell hierarchy. The original service hierarchy is divided into multiple cells, among which adjacent cells adopt different scrambling codes, such as scrambling code1, scrambling code2, . . . , scrambling code7 shown in FIG. 5. There are up-link physical channels and down-link physical channels in original service hierarchy. The down-link physical channels include public pilot channel, broadcast channel, paging channel and other service channels, and these channels are indicated by corresponding scrambling codes of the cell, such as scrambling code1, scrambling code2, . . . , scrambling code7 shown in FIG. 5. The broadcast service hierarchy is also divided into multiple cells and the cell structure is totally the same as that of the original service hierarchy, and adjacent cells adopt the same scrambling codes. The down-link physical channel includes special broadcast channel (the other one is idle), which is indicated as scrambling code 1′ in each cell. The cell structure of original service hierarchy and broadcast service hierarchy over macro cell is formed by combining the two hierarchies together. Each cell is set two special scrambling codes, as scrambling code1+scrambling code1′, scrambling code2+scrambling code1′, . . . , scrambling code7+scrambling code1 shown in FIG. 5. The scrambling code1, scrambling code2, . . . , scrambling code7 are used to support the original service and stay invariable, while scrambling code1′ is used to support the newly added real-time broadcast service.

In the above-mentioned structure, the operating mode of the mobile terminal keeps unchanged for the original service. The mobile terminal can support real-time broadcast service under both idle mode and connecting mode.

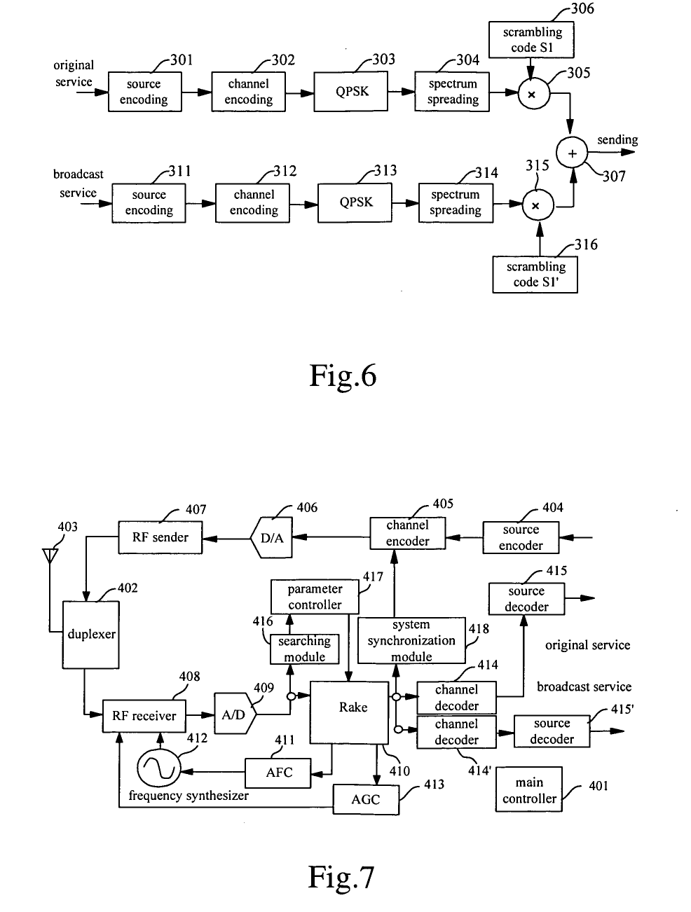

With reference to FIG. 6, this figure illustrates the flow of setting the down-link original service scrambling code and down-link special scrambling code in base station transmitter when sending real-time broadcast programs, including the modulating and spread spectrum process for both the original service and the broadcast service. When the down-link special scrambling code is being set, every cell is set two scrambling codes. The scrambling for original service keeps unchanged, namely only scrambling for broadcast service is needed to be added. The modulation and frequency spreading for original service is implemented through scrambling signals with scrambling code S1 (306) in multiplier 305 after source encoding 301, channel encoding 302, Quaternary Phrase-Shift Keying (QPSK) 303 and spectrum spreading 304 for the signals. The modulation and frequency spreading for broadcast service is implemented through scrambling signals with scrambling code S1′ (316) in multiplier 315 after source encoding 311, channel encoding 312, Quaternary Phrase-Shift Keying (QPSK) 313 and spectrum spreading 314 for the signals. The results of the two services after being scrambled are combined in adder 307, and sent after being amplified by the shared power amplification unit. In practice, the two scrambled results can be firstly amplified by individual power amplification unit respectively, and then sent after being combined.

When there is no broadcast program for the base station sender to send, the down-link special scrambling code S1′ can be removed so as to increase the network capacity.

With reference to FIG. 7, this figure illustrates the structure and operating principle of the mobile terminal when the technology scheme of using special scrambling codes is adopted. The terminal includes a main controller 401, a sending unit which is comprised of a source encoder 404, a channel encoder 405, a Digital/Analog (D/A) converter 406 and a Radio Frequency (RF) sender 407, a receiving unit which is comprised of a Radio Frequency (RF) receiver 408, an Analog/Digital (A/D) converter 409, a frequency synthesizer 412, a searching module 416, a parameter controller 417, a RAKE combining receiver 410, an Automatic Frequency Control (AFC) module 411, an Automatic Gain Correction (AGC) module 413, a channel decoder for original service 414, a source decoder for original service 415, a channel decoder for broadcast service 414′, a source decoder for broadcast service 415′ and a system synchronization module 418, as well as an antenna 403 and a duplexer 402 shared by the sending unit and the receiving unit.

In the mobile terminal for implementing the above-mentioned technology scheme, a channel decoder module 414′ and a source decoder module 415′ for processing broadcast service scrambling codes are added after the special RAKE combining receiver 410 based on the existing hardware structure of mobile terminal. This special RAKE combining receiver 410 is used for receiving special broadcast service besides original service, and the scrambling code 1′ of demodulating unit in the RAKE combining receiver 410 and channel code is the special broadcast channel code S1′ (shown in FIG. 6).

The mobile terminal supports broadcast service under both idle mode and connecting mode and the basic procedures are the same. Taking the idle mode for example, when the user needs to receive real-time broadcast, the mode of the terminal is switched to broadcast mode, while the terminal is still under idle mode for the original service.

When the terminal is receiving broadcast service in a macro cell, according to the channel estimation result for the public pilot frequency of this cell and the channel estimation result for the public pilot frequency of one or multiple adjacent cells with powerful signals, the received signals of multi cells are merged and the signals on broadcast channel are demodulated. Hereby, the terminal can still select and reselect cells, implement location update and receive paging information in terms of the process of original service.

When the terminal is receiving broadcast service in a micro cell or a pico cell, the processing is the same as above except that the broadcast service is not available in this cell. If the signal quality for broadcast service is below the service requirement, a macro cell must be selected to replace the original cell for receiving broadcast service.

To reduce interference from the added down-link scrambling code (such as scrambling code 1′) to other service channels in the cell, the interference value from the added down-link scrambling code to other service channels can be estimated through the demodulated broadcast channel data and the known channel transmission condition, scrambling code, channel code etc. Then this interference value is subtracted from the received signal, thereby the receiving performance of other service channels is improved.

In the present invention, a method for providing real-time broadcast service in a mobile communication network is proposed by setting special carriers or special scrambling codes, which is especially adapted to provide real-time broadcast service in the 3^{rd} generation Code Division Multiple Access (CDMA) mobile communication system.

1. A method for providing real-time broadcast service in a mobile communication network, comprising:
A. linking real-time broadcast service to the mobile communication network; and
B. adding a broadcast service hierarchy for specially providing real-time broadcast service in an radio access network having an original service hierarchy for providing voice communication; real-time broadcasting the real-time broadcast service to mobile terminals via air interface of the mobile communication network through setting special broadcast resources; the mobile terminal working in either of an original service hierarchy mode and a broadcasting service hierarchy mode which can be switched with each other.

2. The method for providing real-time broadcast service in a mobile communication network according to claim 1, step A comprising: transmitting the content information of real-time broadcast service to an information transmitting server; then accessing the content information of real-time broadcast service to the mobile communication network by the information transmitting server.

3. The method for providing real-time broadcast service in a mobile communication network according to claim 1, under the condition that special carrier resources are adopted as special broadcast resources, step B further comprising: setting only independent down link carrier frequency in the added broadcast service hierarchy for specially providing real-time broadcast service; dividing the broadcast service hierarchy into cells where adjacent cells employ different scrambling codes and defining multiple cells into one location area; under the broadcast service hierarchy mode, the mobile terminal staying in the cell of broadcast service hierarchy, solely controlling the cell handoff when the terminal moves among cells, and monitoring the paging procedure.

4. The method for providing real-time broadcast service in a mobile communication network according to claim 3, further comprising: setting broadcast channel for broadcasting corresponding cell information and paging channel for paging mobile terminals under the broadcast service hierarchy mode in the cell of broadcast service hierarchy.

5. The method for providing real-time broadcast service in a mobile communication network according to claim 4, wherein said cell information includes location area code and paging channel configuration information of the cell in broadcast service hierarchy, and the frequencies, scrambling codes, Random Access Channel (RACH), AICH public channel relating to RACH and Forward Access Channel (FACH) of the adjacent cells in the original service hierarchy.

6. The method for providing real-time broadcast service in a mobile communication network according to claim 3, wherein the scrambling codes in the broadcast service hierarchy and those in the original service hierarchy are either the same or different; the location division for cells of the broadcast service hierarchy and that for cells of the original service hierarchy is either superposed or not.

7. The method for providing real-time broadcast service in a mobile communication network according to claim 3, wherein the cell handoff includes location update which is triggered when the mode of mobile terminal is switched between the broadcast service hierarchy mode and the original service hierarchy mode, and when location area changes under the broadcast service hierarchy mode.

8. The method for providing real-time broadcast service in a mobile communication network according to claim 7, wherein the step of triggering location update when location area changes under the broadcast service hierarchy mode comprises: the mobile terminal obtaining information about the cell in the original service hierarchy, which is adjacent to the current cell in the broadcast service hierarchy, from the broadcast information in broadcast channel in the broadcast service hierarchy, finding a cell in the original service hierarchy where the terminal can stay, and sending a random access request utilizing the Random Access Channel (RACH) in the cell of the original service hierarchy; after receiving the AICH information from the cell of the original service hierarchy, the mobile terminal tuning the receiving frequency to the down-link carrier frequency, starting the search and synchronization for the current cell of the broadcast service hierarchy, meanwhile sending a message containing location update information to the network utilizing the up-link carrier frequency in the original service hierarchy, and waiting to receive location update confirming message at the cell of the current broadcast service hierarchy.

9. The method for providing real-time broadcast service in a mobile communication network according to claim 3, wherein the step of monitoring the paging channel under the broadcast service hierarchy mode is the same as that under the original service hierarchy mode, comprising: the network selecting a cell in corresponding location area according to the received location information of the mobile terminal, and sending down-link paging information according to broadcast service carrier frequency or original service carrier frequency, respectively corresponding to the broadcast service mode or the original service mode.

10. The method for providing real-time broadcast service in a mobile communication network according to claim 3, under the condition that special carrier resources are adopted as special broadcast resources, further comprising: the mobile terminal switching the mode from the broadcast service hierarchy mode to the original service hierarchy mode, making a reply or initiating a call through the original service hierarchy.

11. The method for providing real-time broadcast service in a mobile communication network according to claim 10, wherein the step of the mobile terminal making a reply or initiating a call through the original service hierarchy further comprises: sending information about the adjacent cells in the original service hierarchy by the broadcast service hierarchy utilizing the broadcast channel.

12. The method for providing real-time broadcast service in a mobile communication network according to claim 3, wherein the mobile terminal shares one set of receiving system and synchronizing system under the broadcast service hierarchy mode and the original service hierarchy mode.

13. The method for providing real-time broadcast service in a mobile communication network according to claim 3, wherein the mobile terminal utilizes respective receiving systems and shares one set of synchronizing system under the broadcast service hierarchy mode and the original service hierarchy mode.

14. The method for providing real-time broadcast service in a mobile communication network according to claim 1, under the condition that special scrambling code resources are adopted as special broadcast resources, step B further comprising: setting independent down link special scrambling codes in the added broadcast service hierarchy for specially providing real-time broadcast service; wherein the locations of cells of the broadcast service hierarchy and those of the original service hierarchy are superposed so as to form the structure of the cell of the original service hierarchy plus the cell of the broadcast service hierarchy, and each cell utilizes the same special down link scrambling code and the same special broadcast channel code for transmitting only real-time broadcast information; said down link special scrambling codes for real-time broadcast service are added only in macro cells but micro cells or pico cells; the working mode of mobile terminal keeps unchanged for the original service, pilot channel of the original cell is shared and real-time broadcast service is supported under both idling mode and connecting mode.

15. The method for providing real-time broadcast service in a mobile communication network according to claim 14, wherein the step of setting independent down link special scrambling codes in the broadcast service hierarchy is performed through adding a scrambling operation with the down link special scrambling codes in the base station sender of each cell in the original service macro cell covering hierarchy; the information of the broadcast service hierarchy and that of the original service hierarchy either share the same power amplifier or utilizes respective power amplifiers.

16. The method for providing real-time broadcast service in a mobile communication network according to claim 15, wherein processing of the sender includes modulation and spectrum spreading for original service and that for real-time broadcast service; the modulation and spectrum spreading for original service includes source encoding, channel encoding, Quaternary Phrase-Shift Keying (QPSK), spectrum spreading and scrambling the spectrum spread results utilizing the down-link scrambling codes of each cell for the original service; the modulation and spectrum spreading for real-time broadcast service includes source encoding, channel encoding, QPSK, spectrum spreading and scrambling the spectrum spread results utilizing the down-link special scrambling codes for the real-time broadcast service.

17. The method for providing real-time broadcast service in a mobile communication network according to claim 14, wherein the demodulation unit of RAKE receiver of the mobile terminal adopts down-link special scrambling codes for specially receiving real-time broadcast service; channel decoding and source decoding is implemented respectively for the original service and real-time broadcast service after the signals pass the RAKE receiver; the channel code of RAKE receiver is the special broadcast channel code, namely down-link special scrambling code.

18. The method for providing real-time broadcast service in a mobile communication network according to claim 14, wherein said structure of the cell of the original service hierarchy plus the cell of the broadcast service hierarchy is that range and location division of the cell of the original service hierarchy plus broadcast service hierarchy is the same as that of the macro cell of the original service hierarchy.

19. The method for providing real-time broadcast service in a mobile communication network according to claim 14, wherein the mobile terminal supports real-time broadcast service under both idle mode and connecting mode, the method further comprising: keeping the mobile terminal under idle mode for the original service when the mode of the mobile terminal is switched to broadcast mode from idle mode; when the mobile terminal is located in a macro cell, according to the channel estimation result for the public pilot frequency of this cell and the channel estimation result for the public pilot frequency of one or multiple adjacent cells with powerful signals, merging the received signals of multi cells and demodulating the signals on special broadcast channel; the mobile terminal selecting and reselecting cells, implementing location update and receiving paging information in terms of the process of original service; when the mobile terminal is located in a micro cell or a pico cell, according to the channel estimation result for the public pilot frequency of one or multiple adjacent cells with powerful signals, merging the received signals of multi cells and demodulating the signals on special broadcast channel; the mobile terminal selecting and reselecting cells, implementing location update and receiving paging information in terms of the process of original service.

20. The method for providing real-time broadcast service in a mobile communication network according to claim 14, further comprising: the mobile terminal evaluating the interference value from the added down-link special scrambling codes to service channels through the demodulated special broadcast channel data and the known information about channel transmission condition, scrambling code and channel code, and subtracting this interference value from the received signal.
